(19) United States
(12) Patent Application Publication
(10) Pub. No.: US 2025/0200405 A1
(43) Pub. Date: Jun. 19, 2025

(54) SYSTEMS AND METHODS FOR DETERMINISTIC SOLUTIONS TO RANDOM PROBABILITY NETWORKS

(71) Applicant: Aurora Ann, LLC, Las Vegas, NV (US)

(72) Inventor: Craig Trivelpiece, Las Vegas, NV (US)

(21) Appl. No.: 18/545,161

(22) Filed: Dec. 19, 2023

(51) Int. Cl. G06N 7/01

(52) U.S. Cl. CPC G06N 7/01

(57) ABSTRACT

Systems and methods for controlling operations of a computing device. The methods comprise: obtaining, by a simulation system (SS), a start time (ST) for a task; providing ST from a single start node of SS to intermediary nodes of branch(es); performing, by each of the intermediary nodes, look-up table operations to obtain probability values indicating probabilities that the task will be completed at respective times given ST, wherein the probability values are indexed in LUT(s) by time values; performing combining operations by a single end node of SS to combine the probability values output from the intermediary nodes to obtain combined probability values collectively defining a combined probability curve; using the combined probability curve to confirm that a completion time for the task will likely be met; and automatedly controlling operations of the computing device to perform the task based on the using.

### BACKGROUND

### Statement of the Technical Field

The present document concerns computing systems. More specifically, the present document concerns systems and methods for deterministic solutions to random probability networks.

### Description of the Related Art

Monte Carlo algorithms are often used by computer systems to simulate future events. Monte Carlo algorithms generally rely on repeated random sampling to obtain numerical results representing probabilities of the future events. The numerical results are often presented as a histogram or curve (e.g., a discrete probability density function (PDF) graph(s) and/or a cumulative distribution function (CDF) curves (S curves)).

There are two issues with using Monte Carlo to control systems and solve problems. The first is that the number of iterations using random numbers to get a workable solution can take minutes to hours depending on the number of simulated events. One must decide how many iterations of simulation will produce the necessary approximation accuracy for a given application. The second issue is that the random data used creates solution profiles or curves that approach the theoretical exact answer but can have significant variations caused by random number grouping making the end result too inaccurate.

### SUMMARY

This document concerns implementing systems and methods for controlling operations of a computing device. The methods comprise: obtaining, by a simulation system, a start time for a task; providing the start time from a single start node of the simulation system to at least two intermediary nodes of one or more branches; performing, by each of the intermediary nodes, look-up table or equation operations to obtain probability values indicating probabilities that the task will be completed at respective times given the start time, wherein the probability values are indexed in a look-up table by time values; performing combining operations by a single end node of the simulation system to combine the probability values output from the at least two intermediary nodes to obtain a plurality of combined probability values collectively defining a combined probability curve; using the combined probability curve to confirm that a completion time for the task will likely be met; and automatedly controlling operations of the computing device to perform the task based on the using.

The more branches may comprise a serial branch in which a first intermediary node of the at least two intermediary nodes is connected in series with a second intermediary node of the at least two intermediary nodes. In this case, the probability values output from the first intermediary node and the probability values output from the second intermediary node may be combined in accordance with the following mathematic equation:

$${O}_{N} = {A}_{0} * {B}_{N} + {A}_{1} * {B}_{N - 1} + … + {A}_{N - 1} * {B}_{1} + {A}_{N} * {B}_{0} ,$$

where O_{N} represents an Nth combined value, A₀-A_{N} each represents a probability value output from the first intermediary node at a respective time unit, and B₀-B_{N} each represents a probability value output from the second intermediary node at a respective time unit.

Additionally or alternatively, the branches may comprise first and second parallel branches each comprising an intermediary node of the at least two intermediary nodes. The intermediary node of the first parallel branch are connected in parallel with the intermediary node of the second parallel branch. In this case, the combining operations may comprise: determining whether there is an overlap between a first probability curve defined by first probability values output from the first intermediary node and a second probability curve defined by second probability values output from the second intermediary node; selecting, as one of the plurality of combined probability values, a greatest probability value from one of the first probability values associated with a first time unit and one of the second probability values associated with the first time unit, when a determination is made that there is no overlap between the first and second probability curves; and/or selecting, as one of the plurality of combined probability values, a product of one of the first probability values associated with a first time unit and one of the second probability values associated with the first time unit, when a determination is made that the first and second probability curves overlap at least at the first time unit.

In some scenarios, the computing device comprises a network node and the task comprises a network communication to a destination node through a network. A first branch is associated with a first route through the network and a second branch is associated with a different second route through the network. The method further comprises selecting a route from the first and second routes based on associated combined probability curves. The computing device is automatedly controlled to communicate a message or packet to the destination node over the selected route.

In other scenarios, the computing device comprises a robotic device which is at least partially moveable to follow a trajectory. A first branch is associated with a first trajectory of a plurality of candidate trajectories and a second branch is associated with a different second trajectory of the plurality of candidate trajectories. The method comprises selecting a trajectory from the first and second trajectories based on associated combined probability curves, wherein the robotic device is automatedly controlled to follow the selected trajectory.

This document concerns a system, comprising: a processor; and a non-transitory computer-readable storage medium comprising programming instructions that are configured to cause the processor to implement a method for controlling operations of a computing device. The programming instructions comprise instructions to: provide a start time for a task to at least two intermediary nodes of one or more branches of a simulation system; cause each of the intermediary nodes to perform look-up table operations to obtain probability values indicating probabilities that the task will be completed at respective times given the start time, wherein the probability values are indexed in a look-up table by time values; cause an end node of the simulation system to perform combining operations to combine the probability values output from the at least two intermediary nodes to obtain a plurality of combined probability values collectively defining a combined probability curve; use the combined probability curve to confirm that a completion time for the task will likely be met; and automatedly controlling operations of a computing device to perform the task.

The branches may comprise a serial branch in which a first intermediary node is connected in series with a second intermediary node. In this case, the probability values output from the first intermediary node and the probability values output from the second intermediary node are combined in accordance with the following mathematic equation:

$${O}_{N} = {A}_{0} * {B}_{N} + {A}_{1} * {B}_{N - 1} + … + {A}_{N - 1} * {B}_{1} + {A}_{N} * {B}_{0} ,$$

where O_{N} represents an Nth combined value, A₀-A_{N} each represents a probability value output from the first intermediary node at a respective time unit, and B₀-B_{N} each represents a probability value output from the second intermediary node at a respective time unit.

Additionally or alternatively, the branches comprise first and second parallel branches each comprising an intermediary node. The intermediary node of the first parallel branch is connected in parallel with the intermediary node of the second parallel branch. In this case, the programming instructions further comprise instructions to: determine whether there is an overlap between a first probability curve defined by first probability values output from the first intermediary node and a second probability curve defined by second probability values output from the second intermediary node; select, as one of the plurality of combined probability values, a greatest probability value from one of the first probability values associated with a first time unit and one of the second probability values associated with the first time unit, when a determination is made that there is no overlap between the first and second probability curves; and/or select, as one of the plurality of combined probability values, a product of one of the first probability values associated with a first time unit and one of the second probability values associated with the first time unit, when a determination is made that the first and second probability curves overlap at least at the first time unit.

In some scenarios, the computing device may comprise a network node and the task comprises a network communication to a destination node through a network. A first branch is associated with a first route through the network and a second branch is associated with a different second route through the network. The programming instructions further comprise instructions to select a route from the first and second routes based on associated combined probability curves, wherein the computing device is automatedly controlled to communicate a message or packet to the destination node over the selected route.

In those or other scenarios, the computing device comprises a robotic device which is at least partially moveable to follow a trajectory. The first or a third branch is associated with a first trajectory of a plurality of candidate trajectories, and the second or a fourth branch is associated with a different second trajectory of the plurality of candidate trajectories. The programming instructions further comprise instructions to select a trajectory from the first and second trajectories based on associated combined probability curves, wherein the robotic device is automatedly controlled to follow the selected trajectory.

### BRIEF DESCRIPTION OF THE DRAWINGS

This disclosure is facilitated by reference to the following drawing figures, in which like numerals represent like items throughout the figures.

FIG. 1 provides an illustration of a system implementing the present solution.

FIGS. 2-6 each provides an illustration of a probability curve generated in accordance with the present solution.

FIG. 7 provides a graph showing results of a Monte Carol combination with inaccuracies.

FIG. 8 provides a block diagram of another system implementing the present solution.

FIG. 9 provides an illustration of a computing device.

FIG. 11 provides a block diagram of an illustrative architecture for an autonomous robot.

FIG. 11 provides a flow diagram of an illustrative method for controlling operations of a computing device.

FIG. 12 provides a graph showing curves with similar averages but different variability.

### DETAILED DESCRIPTION

It will be readily understood that the solution described herein and illustrated in the appended figures could involve a wide variety of different configurations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

Reference throughout this specification to features, advantages, or similar language does not imply that all of the features and advantages that may be realized should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

As noted above, Monte Carlo has the following drawbacks when used to control systems and solve problems: (1) a relative long amount of time to generate a workable solution; and (2) end results are produced that are too inaccurate for many applications. The present solution addresses these issues of Monte Carlo. The present solution can be used in real-time systems and ones requiring or benefiting from higher accuracy than the standard Monte Carlo system can achieve. The present solution produces the theoretical ideal accuracy and curve while generating the answer at least 1000's times faster than standard random number methods. This increased speed enables the use of the present solution in systems that would have been too slow using the current methods.

The present solution does not implement a Monte Carlo algorithm but a faster and more accurate algorithm to find solutions that typically can only be solved by Monte Carlo methods. In this regard, the present solution implements interconnected nodes connected with some nodes in series and/or others in parallel. Each node is given a probability curve which represents a range of values (e.g., positions, accuracy, measurable values or other characteristics) and the probability of the node's value being at each specific point within that range. These probability curves may be standard waveforms (such as Gaussian, triangle, straight line and others) but could also be generated by historical measurements to produce an empirical probability curve that reflects recent or historical behavior.

Another issue with Monte Carlo simulations is that any change to any of the node's probability curve in a complex system of nodes requires the full Monte Carlo simulation again to see the effect of any change to any of the nodes or connections between nodes on the final result. This is not the case with the present solution. The present solution enforces an assumption that the complex node has a single point of input and output although both input and output can be composed of multiple nodes in parallel. With the present solution, changing the probability curve of a single node, only affects the “downstream” nodes. In other words, only series and parallel nodes between the changed node and the output node are affected. This means on average the computation required to find the effect of a node change is 50% less than redoing the entire computation. In applications such as project management or time based completion calculations, updating the final probability only needs to be done using current and future nodes as nodes representing the past can be ignored at that point so again computations from changes are calculated quicker.

The present solution can be used in various applications. Such applications can include, but are not limited to, integrated master schedule (IMS) applications, project cost applications, machine learning applications, financial market applications, event planning applications, robotic control applications, autonomous vehicle application, and/or any other applications in which prediction of future events is needed. An IMS is known in the art as generally comprising a time-based schedule for network tasks and/or events.

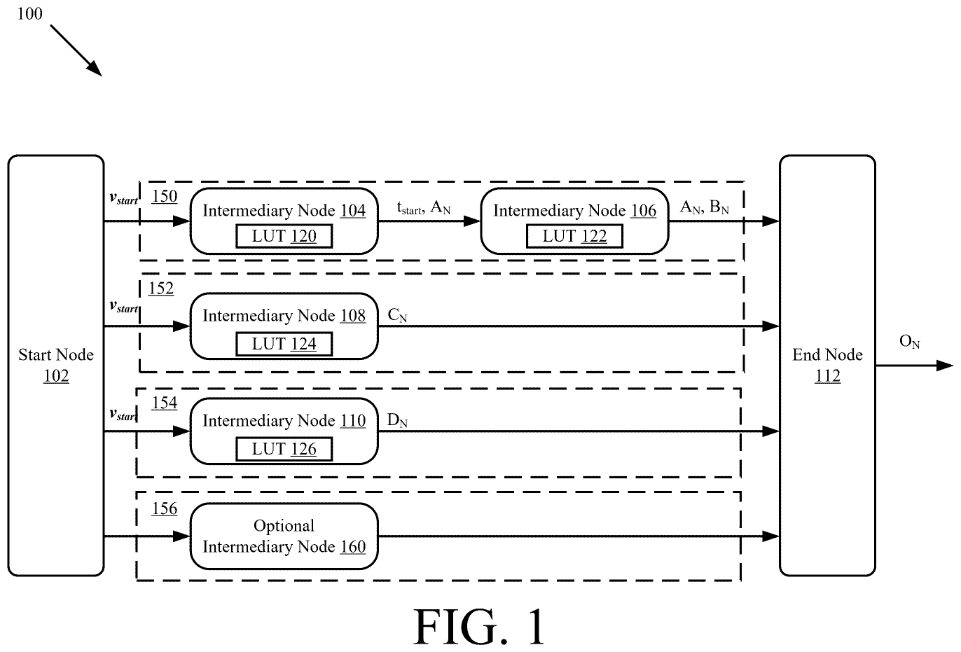

FIG. 1 provides an illustration that is useful for understanding the present solution. The present solution comprises a system 100 that is generally configured to generate one or more probability curves indicating the probabilities that a task or an event will be completed by a specified completion time, a specified completion date, and/or within a specified amount of time.

System 100 comprises a start node 102, one or more branch(es) 150-154, and an end node 112. Branch 150 comprises two intermediary nodes 104 and 106 that are connected in series between the start node 102 and the end node 112. Thus, branch 150 may be referred to as a serial node branch. Branch 152 comprises an intermediary node 108 that is connected in parallel with the intermediary nodes 104, 106 of branch 150 between the start node 102 and the end node 112. Similarly, branch 154 comprises an intermediary node 110 that is connected in parallel with the intermediary nodes 104, 106 of branch 150 and is connected in parallel with intermediary node 108 of branch 152. Branches 152 and 154 may be referred to as parallel node branches. The present solution is not limited to the particular node architecture shown in FIG. 1. System 100 can include any number of start nodes, serial node branches, parallel node branches, and/or end nodes selected in accordance with a given application. For example, in some applications, system includes only one or more serial node branches. In other applications, the system includes only one or more parallel node branches.

Each node is configured to perform look-up table (LUT) operations using an LUT. Each LUT 120, 122, 124, 126 comprises an array that replaces runtime computation with a simpler array indexing operation. The runtime computation is defined by a probability distribution or other mathematical function that gives the probabilities of occurrences of different possible outcomes for a task or event. The probability distribution is generated using empirical data or Gaussian or other distribution data. The empirical data can include, but is not limited to, historical routing data for a network and/or measurement data.

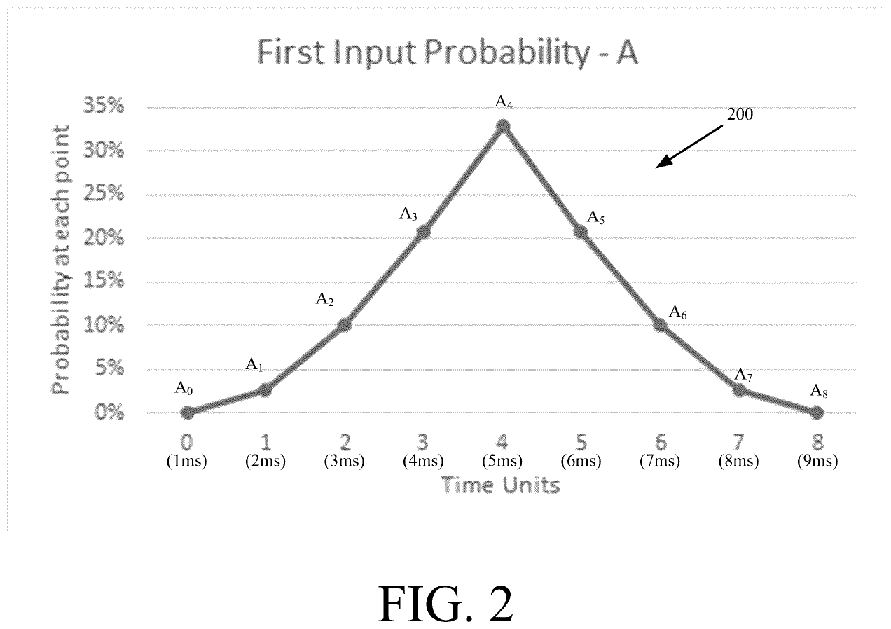

In the LUT(s), probability values may be indexed by time or other value. An illustrative graph is provided in FIG. 2 for a probability curve implemented by the LUT 120 of intermediary node 104. The corresponding LUT 120 may be defined by the following TABLE 1.

TABLE 1

| Time | Probability |
|---|---|
| 1 ms (corresponds to time unit 0) | 0% |
| 2 ms (corresponds to time unit 1) | 3% |
| 3 ms (corresponds to time unit 2) | 10% |
| 4 ms (corresponds to time unit 3) | 20.5% |
| 5 ms (corresponds to time unit 4) | 33% |
| 6 ms (corresponds to time unit 5) | 20.5% |
| 7 ms (corresponds to time unit 6) | 10% |
| 8 ms (corresponds to time unit 7) | 3% |
| 9 ms (corresponds to time unit 8) | 0% |

In a network routing scenarios, the percentage at time unit 1 may represent the faster time if there was no other demand on a network node in a given path. As the demand on the network node increases, the more delay there is in task completion. The percentage represents the likelihood that the delay will be 1 ms, 2 ms, 3 ms, etc. The delay is 4 ms on average. The present solution is not limited to the particulars of this example.

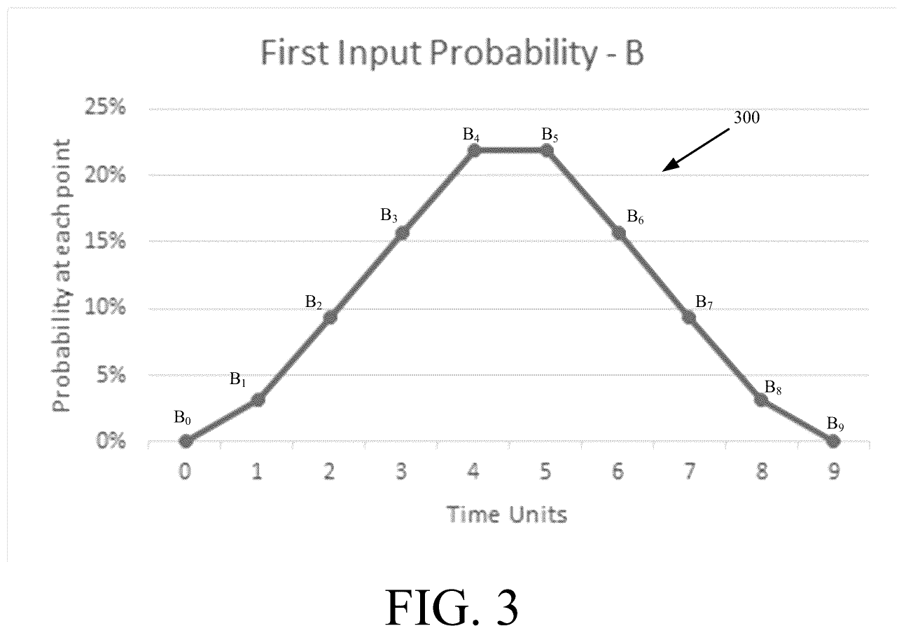

An illustrative graph is provided in FIG. 3 for a probability curve implemented by the LUT 122 of intermediary node 106. The corresponding LUT 122 may be defined by the following TABLE 2.

TABLE 2

| Time | Probability |
|---|---|
| 0 | 0% |
| 1 | 3.5% |
| 2 | 9.7% |
| 3 | 15.2% |
| 4 | 22% |
| 5 | 22% |
| 6 | 15.2% |
| 7 | 9.7% |
| 8 | 3.5% |
| 9 | 0% |

During operation, a start node 102 provides a start value vₛₜₐᵣₜ to each of the branches 150, 152, 154. The start value may include, but is not limited to, a start time for a task or event. For example, in an autonomous vehicle routing scenario, the start value comprises a start time of a trip from a start location to a destination location. Each branch is associated with a respective vehicle trajectory of a plurality of candidate trajectories. The branches may be provided the same start value in this case. In a task scenario, the start value may comprise a start time of a task or a start time of a sub-tasks. Each branch is associated with a respective one of the sub-tasks. The branches 150-154 may be provided the same start value representing the task's start time in some scenarios or alternatively different start values representing sub-task start times in other scenarios. The present solution is not limited to the particulars of these examples and scenarios.

With regard to branch 150, the start value vₛₜₐᵣₜ is received by intermediary node 104. The intermediary node 104 then performs LUT operations to obtain a probability value A_{N} indexed by the start value vₛₜₐᵣₜ. The probability value A_{N} is then passed to intermediary node 106. At intermediary node 106, the start value vₛₜₐᵣₜ is used to obtain a probability value B_{N} from LUT 122.

The two probability values A_{N} and B_{N} are then provided from the intermediary node 106 to the end node 112. The end node performs a computation to combine the two probability values to obtain a serial branch output value O_{N}. This process is repeated for a specified number of incremented time values. The serial branch output values can be defined by the following mathematical equations (1)-(9).

$${O}_{0} = {A}_{0} * {B}_{0} \qquad ( 1 )$$

$${O}_{1} = {A}_{0} * {B}_{1} + {A}_{1} * {B}_{0} \qquad ( 2 )$$

$${O}_{2} = {A}_{0} * {B}_{2} + {A}_{1} * {B}_{1} + {A}_{2} * {B}_{0} \qquad ( 3 )$$

$${O}_{3} = {A}_{0} * {B}_{3} + {A}_{1} * {B}_{2} + {A}_{2} * {B}_{1} + {A}_{3} * {B}_{0} \qquad ( 4 )$$

$${O}_{4} = {A}_{0} * {B}_{4} + {A}_{1} * {B}_{3} + {A}_{2} * {B}_{2} + {A}_{3} * {B}_{1} + {A}_{4} * {B}_{0} \qquad ( 5 )$$

$${O}_{5} = {A}_{0} * {B}_{5} + {A}_{1} * {B}_{4} + {A}_{2} * {B}_{3} + {A}_{3} * {B}_{2} + {A}_{4} * {B}_{1} + {A}_{5} * {B}_{0} \qquad ( 6 )$$

$${O}_{6} = {A}_{0} * {B}_{6} + {A}_{1} * {B}_{5} + {A}_{2} * {B}_{4} + {A}_{3} * {B}_{3} + {A}_{4} * {B}_{2} + {A}_{5} * {B}_{1} + {A}_{6} * {B}_{0} \qquad ( 7 )$$

$${O}_{7} = {A}_{0} * {B}_{7} + {A}_{1} * {B}_{6} + {A}_{2} * {B}_{5} + {A}_{3} * {B}_{4} + {A}_{4} * {B}_{3} + {A}_{5} * {B}_{2} + {A}_{6} * {B}_{1} + {A}_{7} * {B}_{0} \qquad ( 8 )$$

$${O}_{8} = {A}_{0} * {B}_{8} + {A}_{1} * {B}_{7} + {A}_{2} * {B}_{6} + {A}_{3} * {B}_{5} + {A}_{4} * {B}_{4} + {A}_{5} * {B}_{3} + {A}_{6} * {B}_{2} + {A}_{7} * {B}_{1} + {A}_{8} * {B}_{0} \qquad ( 9 )$$

$$…$$

where O₀ represents a first output value associated with a first time unit, O₁ represents a second output value associated with a second time unit, O₂ is represents a third output value associated with a third time unit, O₃ represents a fourth output value associated with a fourth time unit, O₄ represents a fifth output value associated with a fifth time unit, O₅ represents a sixth output value associated with a sixth time unit, O₆ represents a seventh output value associated with a seventh time unit, O₇ represents an eighth output value associated with an eighth time unit, and O₈ represents a ninth output value associated with a ninth time unit, A₀-A₈ represents output values of the intermediary node 104, and B₀-B₈ represents output values of the intermediary node 106.

The above mathematical equation may be generalized by the following mathematical equations (10)-(13).

$${O}_{0} = {A}_{0} * {B}_{0} \qquad ( 10 )$$

$${O}_{1} = {A}_{0} * {B}_{1} + {A}_{1} * {B}_{0} \qquad ( 11 )$$

$${O}_{2} = {A}_{0} * {B}_{2} + {A}_{1} * {B}_{1} + {A}_{2} * {B}_{0} \qquad ( 12 )$$

$$…$$

$${O}_{N} = {A}_{0} * {B}_{N} + {A}_{1} * {B}_{N - 1} + … + {A}_{N - 1} * {B}_{1} + {A}_{N} * {B}_{0} \qquad ( 13 )$$

The output values A₀-A₈ of the intermediary node 104 can be plotted to define a probability curve. An illustrative probability curve 200 is shown in FIG. 2. The output values B₀-B₈ of the intermediary node 106 can be plotted to define a probability curve. An illustrative probability curve 300 is shown in FIG. 3.

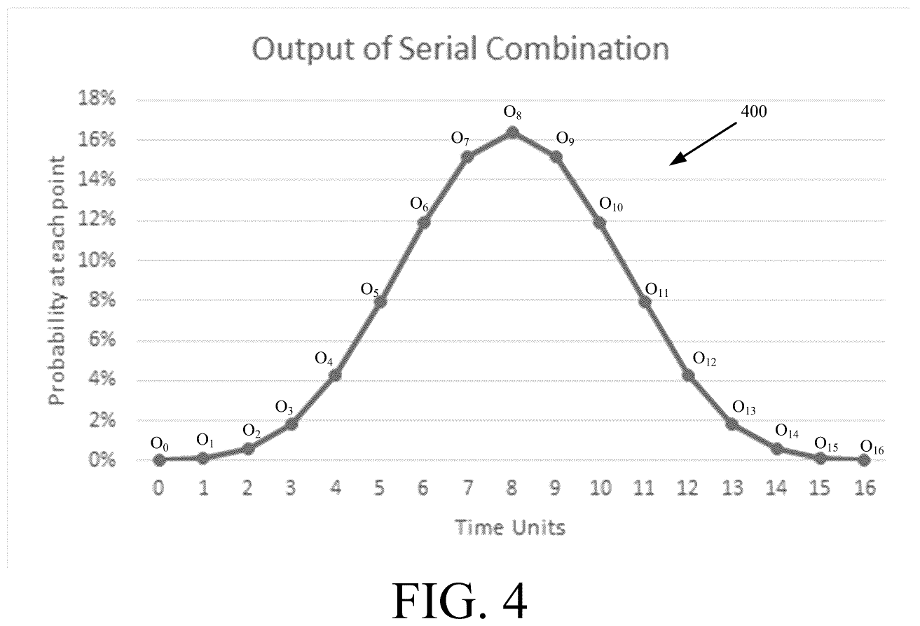

The output values O₀-O₅ can be plotted on a graph to define a combined probability curve. An illustrative combined probability curve 400 is shown in FIG. 4. In a network routing scenario, the combined probability curve 400 indicates that (i) there is a 16% chance that completion of the message communication will take eight units of time (e.g., 8 ms) and (ii) this is the most likely to scenario. The curve also indicates that there is a lower probability of the message communication will be completed in less units of time (see left side of curve) (e.g., <8 ms) or more units of time (see right side of curve) (e.g., >8 ms). The present solution is not limited to the particulars of this example.

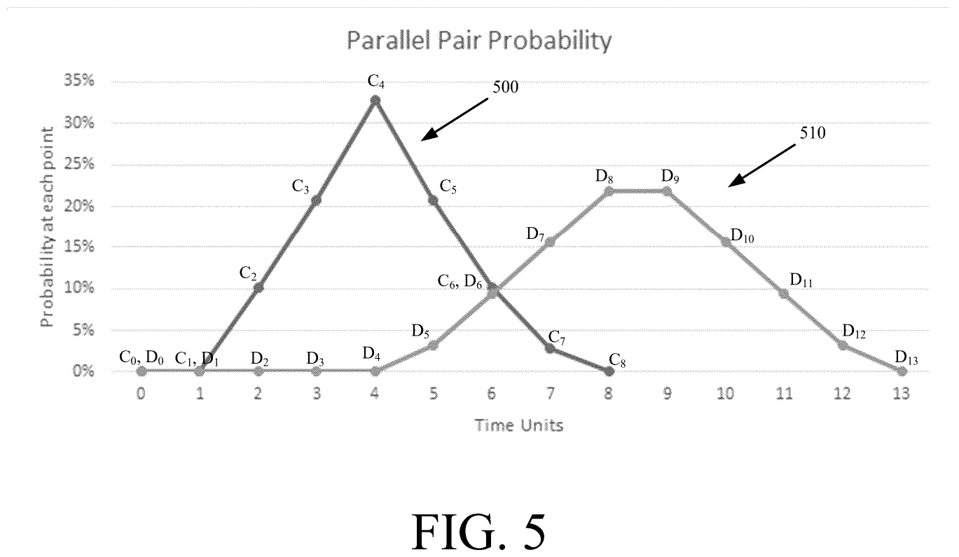

Operation of parallel branches 152, 154 will now be discussed. The parallel branches may be provided the same start value or different start values. For example, in a network routing scenario, the branches 152, 154 may be provided the same start value. The intermediary node 108 of branch 152 will perform LUT operations using the start value vₛₜₐᵣₜ as an index to obtain probability value(s) C_{N} from an LUT 124. The probability value(s) C_{N} can be plotted to define a probability curve. An illustrative probability curve 500 is shown in FIG. 5. The probability curve 500 indicates that there is a 33% chance that the message communication will be completed in 4 time units (e.g., 4 ms) if a respective network path is used, and that this is the most likely scenario. There is a lower probability that the message communication will take less time (e.g., <4 ms) or greater time (e.g., >4 ms). Similarly, the intermediary node 110 of branch 154 will perform LUT operations using the start value vₛₜₐᵣₜ as an index to obtain probability value(s) D_{N} from an LUT 126. The probability value(s) D_{N} can be plotted to define a probability curve. An illustrative probability curve 510 is shown in FIG. 5. The probability curve 510 indicates that there is a 22% chance that the message communication will be completed in 8-9 time units (e.g., 8-9 ms) if a respective network path is used, and that this is the most likely scenario. There is a lower probability that the message communication will be completed in less time units (e.g., <8-9 ms) or greater time units (e.g., >8-9 ms). The present solution is not limited to the particulars of this example.

In a task performance scenario, the branches may be provided different start times associated with respective sub-tasks. For example, branch 152 is associated with a first sub-task that has a first start time vₛₜₐᵣₜ₋₁ (e.g., 1 ms), while branch 154 is associated with a second sub-task that has a second different start time vₛₜₐᵣₜ₋₂ (e.g., 4 ms). The intermediary node 108 of branch 152 will perform LUT operations using the first start value vₛₜₐᵣₜ₋₁ as an index to obtain probability value(s) C_{N} from an LUT 124. The probability value(s) C_{N} can be plotted to define a probability curve. An illustrative probability curve 500 is shown in FIG. 5. The probability curve 500 indicates that there is a 33% chance that the first sub-task will be completed in 4 time units (e.g., 4 ms), and that this is the most likely scenario. There is a lower probability that the first sub-task will be completed in less time (e.g., <4 ms) or greater time (e.g., >4 ms). Similarly, the intermediary node 110 of branch 154 will perform LUT operations using the second different start value vₛₜₐᵣₜ₋₂ as an index to obtain probability value(s) D_{N} from an LUT 126. The probability value(s) D_{N} can be plotted to define a probability curve. An illustrative probability curve 510 is shown in FIG. 5. The probability curve 510 indicates that there is a 22% chance that the second sub-task will be completed in 8-9 time units (e.g., 8-9 ms), and that this is the most likely scenario. There is a lower probability that the second sub-task will be completed in less time units (e.g., <8-9 ms) or greater time units (e.g., >8-9 ms).

The probability value(s) C_{N} and D_{N} are combined at end node 112 to produce combined output values O_{N}. This combining operation can be defined by the following mathematical equations. It should be noted that in this case, the combining starts with the values associated with the fourth time unit since that is the time unit that the probability value starts to increase from zero percent. Consequently, the values of O₁-O₄ are set to zero. Since the last value C₈ of curve 500 ends at the eighth time unit, the output values D₉-D₁₃ for curve 510 are simply multiplied by one.

$${O}_{4} = {C}_{4} * {D}_{4} \qquad ( 10 )$$

$${O}_{5} = {C}_{5} * {D}_{5} \qquad ( 11 )$$

$${O}_{6} = {C}_{6} * {D}_{6} \qquad ( 12 )$$

$${O}_{7} = {C}_{7} * {D}_{7} \qquad ( 13 )$$

$${O}_{8} = {C}_{8} * {D}_{8} \qquad ( 14 )$$

$${O}_{9} = 1 * {D}_{8} \qquad ( 15 )$$

$${O}_{10} = 1 * {D}_{10} \qquad ( 16 )$$

$${O}_{11} = 1 * {D}_{11} \qquad ( 17 )$$

$${O}_{12} = 1 * {D}_{12} \qquad ( 18 )$$

$${O}_{13} = 1 * {D}_{13} \qquad ( 19 )$$

The curve 600 indicates that there is a 20% probability that the task will be completed in 8-9 time units, and that this is the most likely outcome. Curve 600 also indicates that there is a lower probability that the task will be completed in less time units (e.g., <8-9 ms) or more time units (e.g., >8-9 ms). This information can then be used by a computing system to determine whether the task can be performed by a particular time/day, to select a particular time/day to perform the task such that it will be completed on time, and/or to determine not to perform or replace a particular sub-task. The present solution is not limited to the particulars of this example.

As evident from the above discussion, system 100 can be used in various applications. Such applications include task/event scheduling applications, network routing applications and/or vehicle routing applications.

In a network routing application, the branches 150, 152, 154 may be associated with different paths or routes through the network from a source device (e.g., a mobile phone) to a destination device (e.g., another mobile phone). For example, serial branch 150 is associated with a first path or route through the network. Parallel branch 152 is associated with a different second path or route through the network, and parallel branch 154 is associated with a different third path or route through the network. The start value vₛₜₐᵣₜ comprises a start time for a message communication from the source device (e.g., a mobile phone) to the destination device (e.g., another mobile phone). System 100 is used by the source device to determine or identify a best route/path through the network to the destination device. The best route or path can be selected based on the output values of the end node 112 indicating completion times of the message communication or other tasks. The best route or path can be selected as the one associated with the output value having the smallest value. Communications components of the source device are then automatically, automatedly and/or autonomously controlled to send the message over the best route or path of the network. The use of system 100 by the source node has many advantages. For example, the present solution provides a relatively faster way to identify best paths/routes to minimize traffic delays in a network and/or to optimize network traffic demands on network nodes. A vehicle routing application may be similar to this example.

An illustrative probability curve 500 generated using a Monte Carlo combination technique is shown in FIG. 5. As can be seen in FIG. 5, the probability curve is not smooth resulting from errors in the probability values. This is undesirable in applications where there are a relatively large number of intermediary nodes in serial branches and/or parallel branches since the errors provide inaccurate results. This is not the case in the present solution.

As evident from the above discussion, the present solution computes each series connection as being a result of the two connected nodes 104, 106 only. Each parallel connection computes all the parallel nodes 106, 108 by combining two connected nodes with each binary parallel result then computed with the next parallel node until all the parallel nodes are accounted for. This method of doing each connection solution as a series of binary computations enables parallel computation methods to further speed up the computation of a complex system using parallel processing.

There are many different boundary conditions that can be used with the present solution. The boundary conditions can include, but are not limited to, the following: (1) each network has a single starting node and a single ending node; (2) each probability or intermediary node has a single input and a single output; (3) each probability curve is normalized so the total area has a value of one hundred percent (note: each result of combining probability curves is renormalized to one hundred percent before use by the next combination); (4) no series of node connections can create a circular path or reference; (5) parallel node combination for time-based solutions may require absolute starting time so probability calculations can compensate for different starting times and length of times; (6) value-based solutions (such as financial instruments like stocks, options, futures, currencies and sports events scores) are often done as predictions using multiple time windows in series to come up with a future probability curve.

The deterministic method of combining probability curves starts with the horizontal axis which usually represents time or value. The vertical axis represents percentage out of one hundred percent. The granularity of the horizontal axis is chosen to provide the necessary resolution and accuracy for the application and takes into account that the finer the granularity the slower the speed and the higher the memory usage. Note that the output width (time units in this case) is always the sum of at least two serial input probability widths. In order to compute an output time of the eighth time unit (e.g., 8 ms), the probability of all of the time slots from intermediary nodes 104, 106 are added. This computation can be defined by the above mathematical equation (9).

As many serial combinations are made, the width of the output will continue to increase with the percentages in the first and last columns becoming insignificant to the probabilities in the middle. These outliers can be totaled and compressed into a single first and last column to keep the width of the output within reasonable and useful lengths for memory storage and computation speed.

Parallel combinations are performed in pairs. If there are more than two curves in parallel, then the first two curves are combined and the result is then combined with the next curve until all curves have been combined and there is a single result. For example, the probability curves of intermediary nodes 108 and 110 are combined to form a first combined curve. The first combined curve may then be combined with a probability curve of intermediary node 160, and so on. There are several different situations involving parallel combinations depending upon their widths, relative starting position and overlaps of the two probability curves. The following outlines overlap situations.
1. If there is no overlap between parallel probabilities, then only the latest in time or the largest in value is used. (For example, with reference to FIG. 5, probability curve 510 does not overlap probability curve 500 at time unit 9-13. So, probability values D₉-D₁₃ are used as probability values at time units 9-13 of the combined probability curve 600.)
2. When one probability curve is completely overlapped by the other probability curve, the non-overlap portion at the beginning is not used and the ending is used unchanged while the middle overlap portion combines the two probabilities. (For example, probability curve 500 is completely overlapped by probability curve 510. So, probability values C₀-C₈ are combined with probability values D₀-D₈ since curves 500, 510 overlap at time units 0-8. Probability values D₉-D₁₃ are used unchanged to produce the combined probability curve 600.)
3. If one probability curve is partially overlapped by the other probability curve, then the non-overlap portion at the beginning is not used and the ending is used unchanged while the middle overlap portion combines the two probabilities. (For example, probability curve 510 is completely overlapped by probability curve 500. So, probability values D₀-D₈ are combined with probability values C₀-C₈ since curves 510, 500 overlap at time units 0-8. Probability values D₉-D₁₃ are used unchanged to produce the combined probability curve 600.)

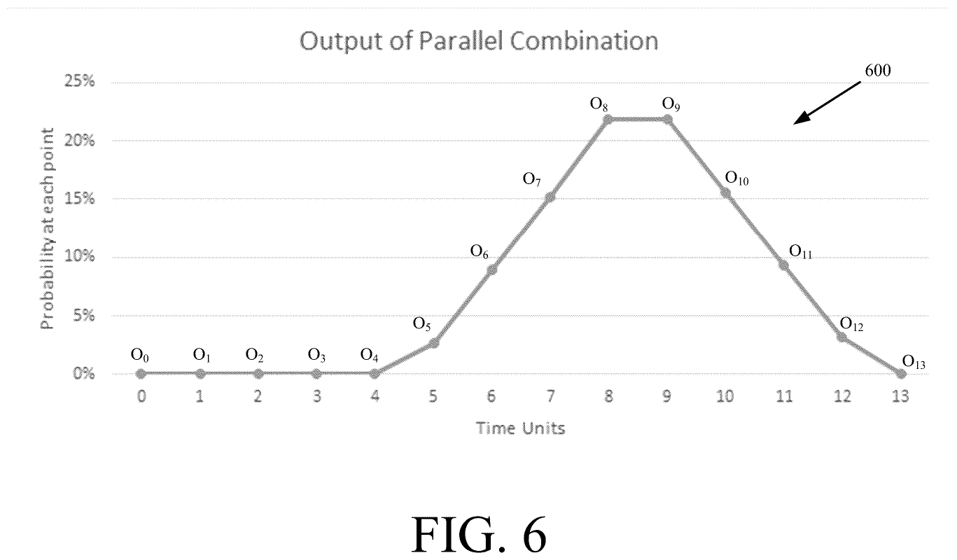

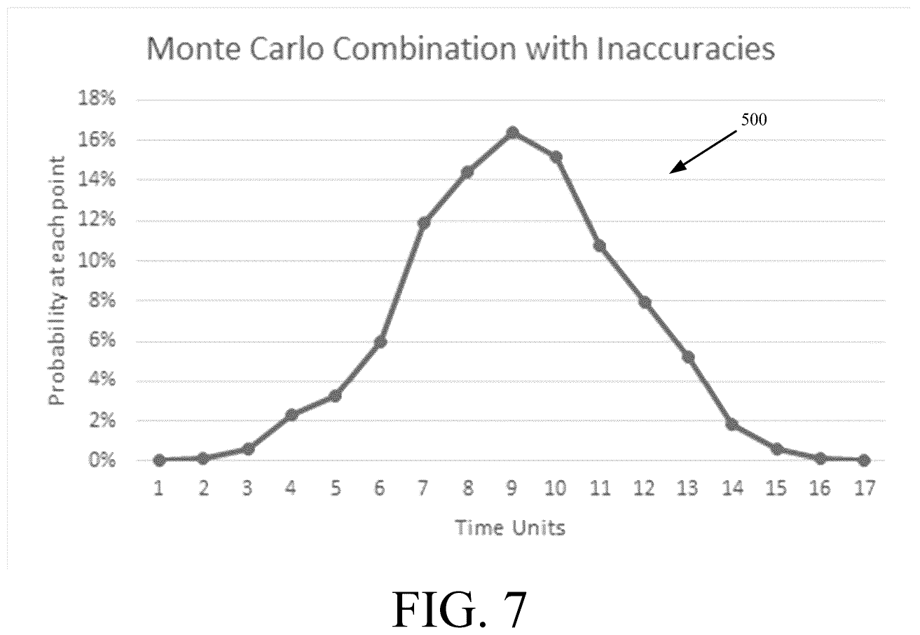

The total width of the parallel combination is the length of the latest one if no overlap or the length starting at the overlap until the end of the non-overlap ending. After combining each pair of probability values, the result may be normalized so the total area sums to one hundred percent. Any known or to be known technique can be used to normalize the probability values. Graphs illustrating the combination of two offset parallel probability curves is provided in FIGS. 5-6.

### Implementing System(s)

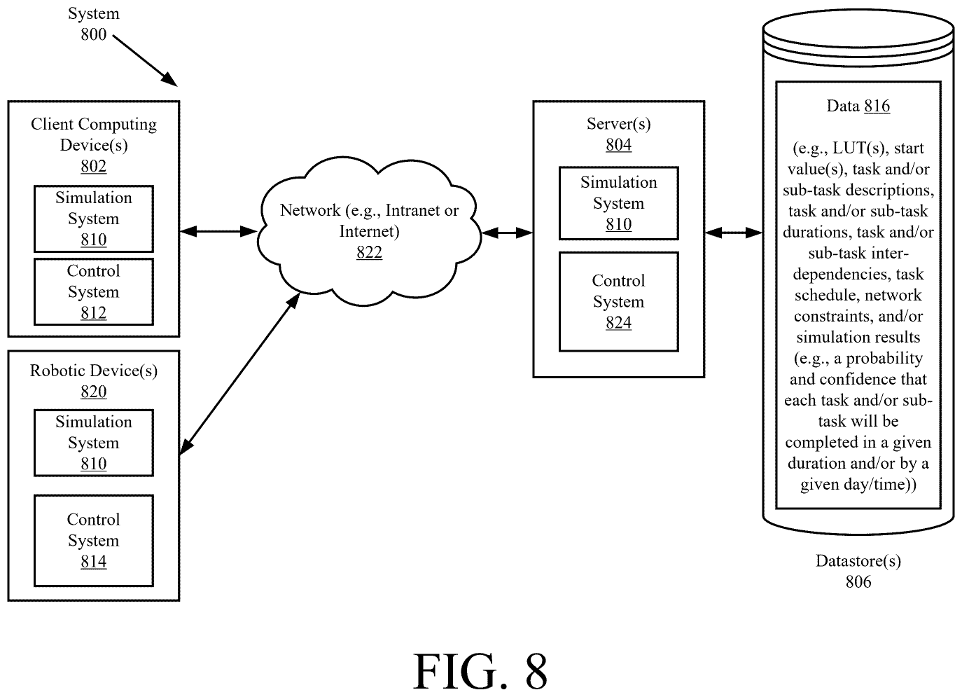

FIG. 8 provides an illustration of a system 800 implementing the present solution. System 800 is generally configured to control client computing device(s) 802 and/or robotic device(s) 820 based on results of the simulation system(s) 810. Simulation system(s) 810 can be the same as or substantially similar to system 100 described above in relation to FIG. 1. Thus, the above discussion of system 100 is sufficient for understanding simulation system(s) 810.

The simulation system(s) 810 can be implemented on the client computing device(s) 802, the robotic device(s) 820 and/or server(s) 804. The client computing device(s) 802 can include, but is (are) not limited to, personal computer(s), desktop computer(s), laptop computer(s), tablet(s), mobile phone(s), cellular phone(s), personal digital assistant(s), smart television(s), and/or any other network node. The robotic device(s) 820 can include, but is (are) not limited to, autonomous vehicle(s), semi-autonomous vehicle(s), human robot(s), robotic animal(s), and/or articulating arm(s).

The simulation system(s) 810 can use data 816 stored in a datastore 806 to simulate tasks and/or events and output probability curves indicating the probability that the tasks/events will be completed in a certain amount of time and/or by a certain completion day and/or time. The data 816 can include, but is not limited to, start value(s) and LUT(s). The start value(s) can include, but is (are) not limited to, vₛₜₐᵣₜ of FIG. 1. The LUT(s) can include, but is (are) not limited to, LUT(s) 120, 122, 124, 126 of FIG. 1. The data can additionally or alternatively be stored locally on the device(s) 802, 804, 820. The devices 802, 804, 820 can communicate with each other via a network 822. Network 822 can include, but is not limited to, the Internet and/or an Intranet.

In network routing applications, operations of network node(s) 802, 804, 820 could be autonomously controlled by: (1) optionally obtaining a machine learning model generated by training a machine learning algorithm to simulate operations of the network and/or network node(s) for generating one or more candidate task schedules; (2) optionally generate one or more candidate task schedules for the network and/or network node(s) using the machine learning model; (3) obtaining a start time for each candidate task schedule; (4) provide the start time and the candidate task schedule to a simulation system 810; and (5) perform operations by the simulation system 810 to configure serial branches (e.g., serial branch 150 of FIG. 1) and/or parallel branches (e.g., parallel branches 152, 154, and/or 156 of FIG. 1). For example, a first branch can be configured such that it will output probability values that are useful for determining whether a first sub-task of the task schedule will be completed in a certain amount of time, and a second branch can be configured such that it will output probability values that are useful for determining whether a second sub-task of the task schedule will be completed in a certain amount of time, and so on. This branch configuration can also involve identifying LUT(s) from a plurality of LUT(s) that should be used by intermediary nodes of the branches. Once the branches and their intermediary nodes are configured, the simulation system 810 uses the start time and LUT(s) to generate a probability curve for each sub-task. The probability curves for the sub-tasks can then be combined to produce a combined curve (i) indicating probabilities that the task will be completed in certain amounts of time and (ii) indicating a most likely scenario (i.e., it is most likely that the task will be completed in a certain amount of time and/or by a certain date). The simulation system 810 will then use the combined curve(s) (i) to confirm that the task can be completed in a certain amount of time and/or by a certain completion date, (ii) to select a best one of the candidate task schedules to be implemented by the network and/or network node, and/or (iii) determine whether a particular sub-task should not be performed and/or replaced with another sub-task so that the completion date will be met. In the event that the sub-task should be replaced, the simulation system operations can be repeated to obtain new probably curves for selected a final candidate task schedule. The simulation system 810 will communicate the results of decision (i), (ii) and/or (iii) to control system(s) 812, 814, and/or 824 for causing operations of the network node(s) 802, 804 and/or 820 to be automatedly, automatically and/or autonomously controlled so that the task is performed and completed in accordance with the best candidate task schedule or the final candidate task schedule.

In a semi-autonomous or autonomous robotic device application, operations of the robotic device 820 could be autonomously controlled by: (1) optionally obtaining a machine learning model generated by training a machine learning algorithm to predict traffic patterns for path segments based on time of day, time of year, geographic location, local events, local construction, accident reports, weather patterns, etc.; (2) generating one or more candidate trajectories for the robotic device in accordance with known technique(s) and/or based on the predicted traffic patterns for path segments; (3) obtaining a start time for the trip or movement; (4) providing the start time and the candidate trajectories to a simulation system 810; and (5) perform operations by the simulation system 810 to configure serial branches (e.g., serial branch 150 of FIG. 1) and/or parallel branches (e.g., parallel branches 152, 154, and/or 156 of FIG. 1) based on the candidate trajectory information. For example, a first branch can be configured such that it will output probability values that are useful for determining whether the robotic device or a portion of the robotic device (e.g., an articulating arm) will reach its destination in a certain amount of time if it follows a first candidate trajectory, and a second branch can be configured such that it will output probability values that are useful for determining whether the robotic device or a portion of the robotic device (e.g., an articulating arm) will reach its destination in a certain amount of time if it follows a different second candidate trajectory, and so on. The branch configuration can also involve identifying LUT(s) from a plurality of LUT(s) that should be used by intermediary nodes of the branches. Once the branches and their intermediary nodes are configured, the simulation system 810 uses the start time and LUT(s) to generate a probability curve for each candidate trajectory. Each probability curve may (1) indicate probabilities that the respective trip will be completed by the autonomous vehicle in certain amounts of time and (2) indicate a most likely scenario (i.e., it is most likely that the respective trip will be completed in a certain amount of time). The simulation system 810 will then use the probability curves (i) to confirm that the trip can be completed by the autonomous vehicle in a certain amount of time (e.g., 10 minutes) and/or (ii) to select a best one of the candidate trajectories to be followed by the autonomous vehicle. The simulation system 810 will communicate the results of decision (i) and/or (ii) to the control system 814 for causing operations of the robotic device 820 to be automatedly, automatically and/or autonomously controlled so that the best candidate trajectory is followed by the robotic device or the portion of the robotic device. Any known technique can be used to control movement of the robotic device.

In view of the foregoing, the simulation system(s) 810 implement(s) methods for precisely and quickly solving complex network routing problems by using probability distributions and creating a final probability distribution answer that gives results for a best path solution and the variations by percentage without the need for random number solutions such as Monte Carlo. The present solution solves IT and other network best routing for combination of serial and parallel paths with a final probability curve and path. The present solution may also be used as: a vehicle traffic routing solution for best times or best certainty with probability curves and showing percentage confidence for various paths; a project management solution for best times or best certainty with probability curves and showing percentage confidence for various project combinations; a solution for financial, stocks and options valuations and certainty percentages for those computations; and/or a solution for control, routing and financial systems that maximizes confidence certainty over best numerical answer. In some scenarios, parallel computation(s) is (are) used for faster results. The granularity or resolution representing the probability may be modified to maximize required speed and/or required accuracy.

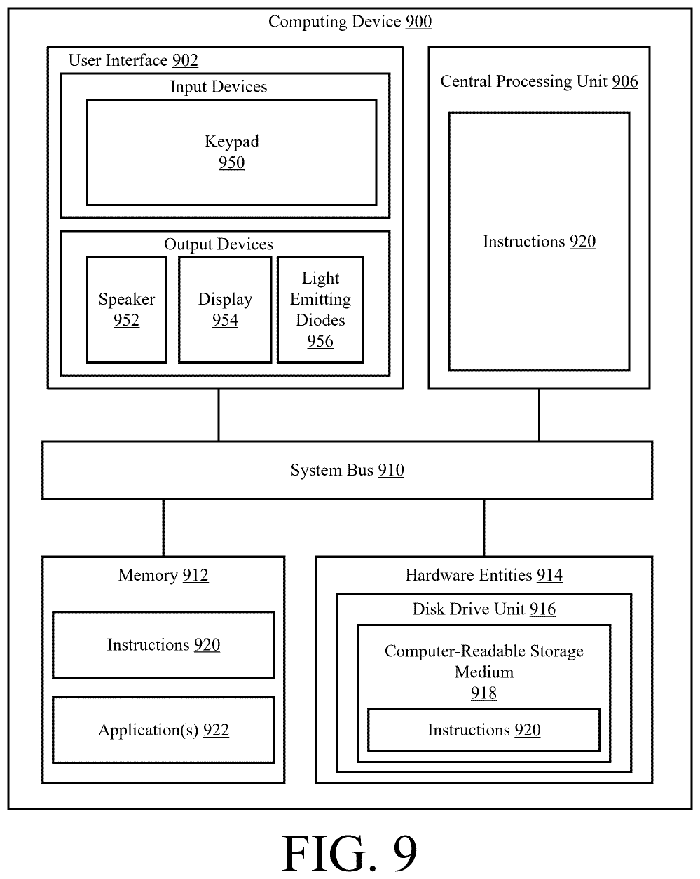

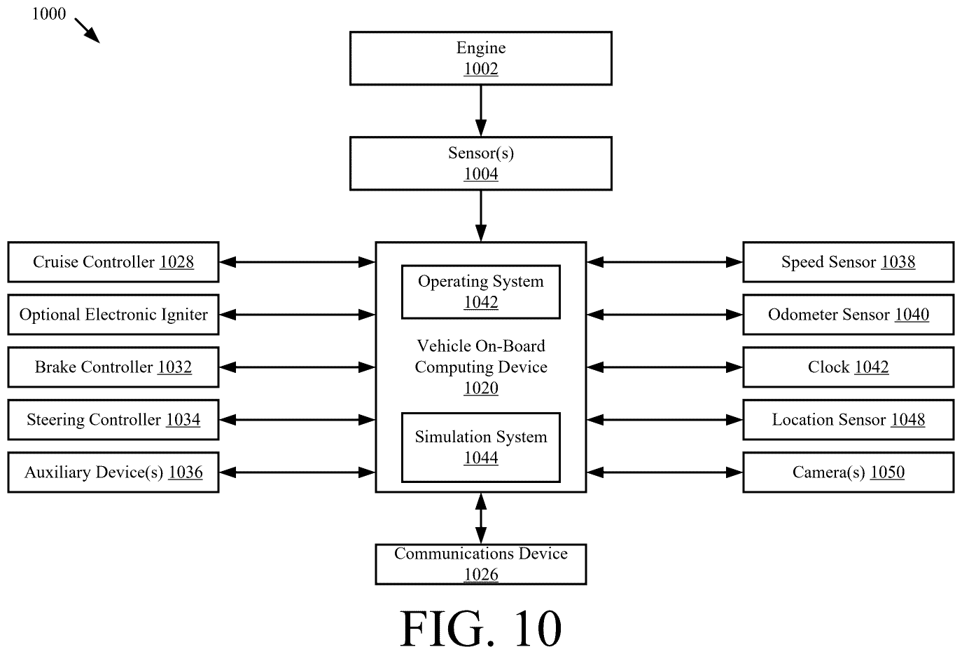

Referring now to FIG. 9, there is shown a hardware block diagram comprising an example computing device 900 that can be used for implementing the present solution. System 100 of FIG. 1, client computing device(s) 802 of FIG. 8, robotic device(s) 820 of FIG. 8, and/or server(s) 804 of FIG. 8 may be the same as or similar to computing device 900. As such, the discussion of computing device 900 is sufficient for understanding systems and devices 100, 802, 804, 820 of FIGS. 1 and 4.

Computing device 900 may include more or less components than those shown in FIG. 9. However, the components shown are sufficient to disclose an illustrative solution implementing the present solution. The hardware architecture of FIG. 9 represents one implementation of a representative computing device configured to enable automatic and/or automated tunnel creation and termination, as described herein. As such, the computing device 900 of FIG. 9 implements at least a portion of the method(s) described herein.

Some or all the components of the computing device 900 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 9, the computing device 900 comprises a user interface 902, a central processing unit (CPU) (or processor) 906, a system bus 910, a memory 912 connected to and accessible by other portions of computing device 900 through system bus 910, and hardware entities 914 connected to system bus 910. The user interface can include input devices and output devices, which facilitate user-software interactions for controlling operations of the computing device 900. The input devices include, but are not limited to, a physical and/or touch keyboard 950. The input devices can be connected to the computing device 900 via a wired or wireless connection (e.g., a Bluetooth® connection). The output devices include, but are not limited to, a speaker 952, a display 954, and/or light emitting diodes 956.

At least some of the hardware entities 914 perform actions involving access to and use of memory 912, which can be a random access memory (RAM), a disk driver and/or a compact disc read only memory (CD-ROM). Hardware entities 914 can include a disk drive unit 916 comprising a computer-readable storage medium 918 on which is stored one or more sets of instructions 920 (e.g., software code) configured to implement one or more of the methodologies, procedures, or functions described herein. The instructions 920 can also reside, completely or at least partially, within the memory 912 and/or within the CPU 906 during execution thereof by the computing device 900. The memory 912 and the CPU 906 also can constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding or carrying a set of instructions 920 for execution by the computing device 900 and that cause the computing device 900 to perform any one or more of the methodologies of the present disclosure.

FIG. 10 provides an illustration of an illustrative system architecture 1000 for a robotic device. Robotic device(s) 820 of FIG. 8 can have the same or similar system architecture as that shown in FIG. 10. Thus, the following discussion of system architecture 1000 is sufficient for understanding robotic device(s) 820 of FIG. 8. Robotic device is described as comprises an autonomous vehicle. cars, trucks, vans, trains, autonomous vehicles, aircraft, aerial drones and the like. The present solution is not limited in this regard. The robotic device can additionally or alternatively comprise an articulating arm and/or other movable component capable of following a trajectory.

As shown in FIG. 10, the system architecture 1000 comprises a vehicle on-board computing device 1020 connected to a communication device 1026. The communication device 1026 is configured to facilitate wired and/or wireless communications with external devices (e.g., client computing device(s) 802 and/or server(s) 804 of FIG. 8). In this regard, the communication device 1026 includes a transceiver and an antenna. Transceivers and antennas are well known in the art. Any known or to be known transceiver and antenna can be used herein. For example, a radio transceiver and a radio antenna can be used here.

The communication device 1026 allows for telemetry of vehicle related information and/or other information. The robotic device 1000 includes an engine 202 and a plurality of sensors 1004 measuring various parameters of the engine 1002. Still, it should be noted that the sensors 1004, in some examples, comprise an exhaust gas sensor, an engine knock sensor, an oil pressure sensor, an engine temperature sensor, a battery voltage sensor, an alternator current sensor, an engine RPM sensor, and a throttle position sensor. Other sensors 1038, 1040, 1048, 1050 are also provided in the robotic device 1000. These sensors include a speed sensor 1038, an odometer sensor 1040, a location sensor 1048 (e.g., a GPS device), and camera(s) 1050. Each of the listed sensors is well known in the art.

During operations, measurement information is communicated from the sensors 1004, 1038, 1040, 1048, and/or 1050 to the vehicle on-board computing device 1020. The vehicle on-board computing device 1020 forwards the measurement data to a remote computing device (e.g., server(s) 804 of FIG. 8) via communications device 1026 and/or locally analyzes the measurement data from the sensors for purposes of detecting road conditions, detecting environmental conditions, detecting objects in proximity to the robotic device, and/or detecting obstructions in a path of the robotic device. A plurality of candidate trajectories for the robotic device can be generated using the listed information and/or other information in accordance with known techniques. The candidate trajectories are evaluated by simulation system 1044 to determine, verify and/or validate that the robotic device can reach its destination when following the same within a given amount of time. The simulation system 1044 implements the present solution as described above. The simulation system 810 of FIG. 8 can be the same as or similar to simulation system 1044. The results of the simulation system 1044 are then stored in a local memory of the vehicle on-board computing device 1020 for later use in the autonomous control of the robotic device 1000. For example, the vehicle on-board computing device 1020 controls braking via a brake controller 1032, a vehicle speed via cruise controller 1028, and/or a vehicle direction via steering controller 1034 in accordance with known techniques.

The operating system 1022 is configured to support the vehicle on-board computing device's basic functions, such as scheduling tasks and executing applications. The simulation system 1044 comprises a computer program that implements all or a portion of the methods described herein for (i) determining, verifying and/or validating candidate trajectories, (ii) selecting one of the candidate trajectories based on results of (i), and (iii) controlling an autonomous device to follow the selected candidate trajectory. The operations of the simulation system 1044 may be the same as or similar to system 100 of FIG. 1 and/or the simulation system 810 of FIG. 8. The clock 1042 is an electrical device for measuring time.

Vehicle history information is logged in a memory (not shown in FIG. 10) of the vehicle on-board computing device 1020, or an external datastore (e.g., datastore 806 of FIG. 8). The vehicle history information includes historical data related to the vehicle, and can be used to determine whether or not the vehicle reached its destination and/or encountered obstructions when following the trajectory. A unique identifier is provided for the vehicle. The vehicle history information is stored so as to be associated with the unique vehicle identifier. The unique vehicle identifier can include numbers, letters, symbols or a combination of the same.

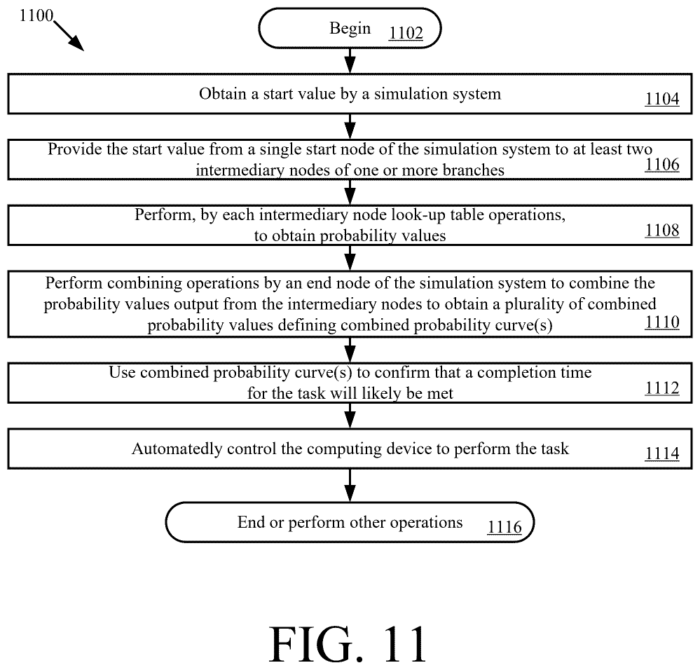

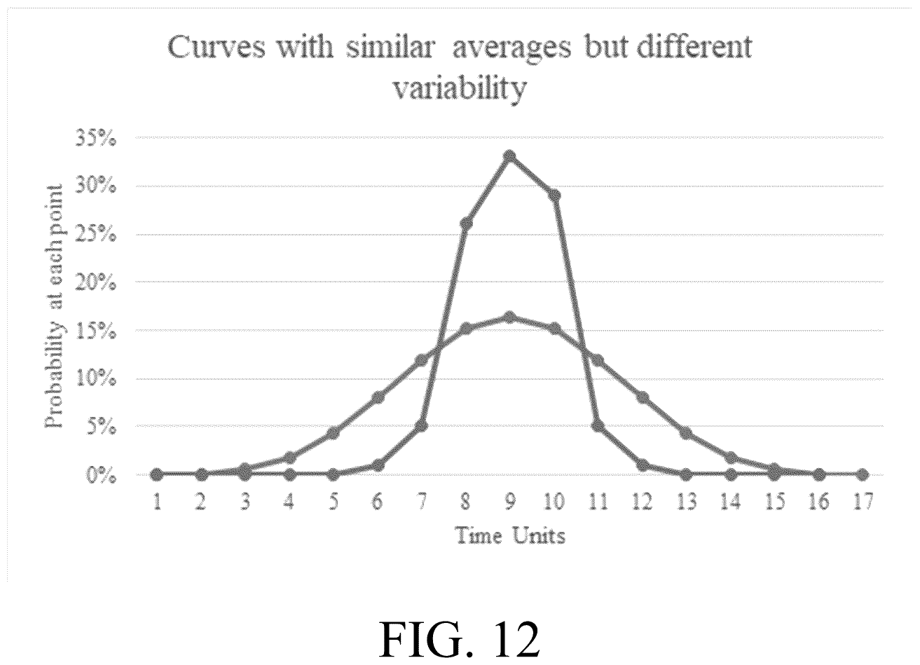

Referring now to FIG. 11, there is provided a flow diagram of an illustrative method 1100 for controlling operations of a computing device (e.g., client computing device 802 of FIG. 8, server 804 of FIG. 8, robotic device 820 of FIG. 8, and/or robotic device 1000 of FIG. 10). Method 1100 begins with 1102 and continues to 1104 where a simulation system (e.g., system 100 of FIG. 1, simulation system 810 of FIG. 8, and/or simulation system 1044 of FIG. 10) obtains a start value (e.g., start value vₛₜₐᵣₜ of FIG. 1). The start value can include, but is not limited to, a start time for a task. The task can include, but is not limited to, a message or packet communication to a destination node in a network, and/or following a trajectory stating from a start location and ending at a destination location. Next in 1106, the start value is provided from a single start node (e.g., start node 102 of FIG. 1) of the simulation system to at least two intermediary nodes (e.g., intermediary node 104, 106, 108, 110, and/or 160 of FIG. 1) of one or more branches (e.g., branches 150, 152, 154 and/or 156 of FIG. 1). Each intermediary node performs look-up table or algorithm operations in 1108 to obtain probability values. The probability values may indicate probabilities that the task will be completed at respective times given the start time. The probability values may be indexed in a look-up table by time values.

In 1110, an end node (e.g., end node 112 of FIG. 1) of the simulation system performs combining operations to combine the probability values output from the intermediary nodes to obtain a plurality of combined probability values defining combined probability curve(s). The combined probability curve(s) is (are) used in 1112 to confirm that a completion time for the task will likely be met. Next in 1114, the computing device is automatedly controlled to perform the task once it is confirmed that its completion time will be met. If it is not confirmed that the completion time for the task will likely not be met with a certain degree of confidence or level of probability, then the tasks can be modified (e.g., by removing or replacing a sub-tasks) and re-analyzed. Alternatively, a next task can be obtained and analyzed to confirm whether it can likely be completed by its completion time. Subsequently, method ends or other operations are performed in block 1116. The other operations can include, but are not limited to, returning to 1102 and repeating operations of blocks 1104-1114.

In some scenarios, the branch comprises a serial branch (e.g., serial branch 150 of FIG. 1) in which a first intermediary node (e.g., intermediary node 104 of FIG. 1) is connected in series with a second intermediary node (e.g., intermediary node 106 of FIG. 1). The probability values output from the first intermediary node and the probability values output from the second intermediary node are combined in block 1010 in accordance with the following mathematic equation:

$${O}_{N} = {A}_{0} * {B}_{N} + {A}_{1} * {B}_{N - 1} + … + {A}_{N - 1} * {B}_{1} + {A}_{N} * {B}_{0} ,$$

where O_{N} represents an Nth combined value, A₀-A_{N} each represents a probability value output from the first intermediary node at a respective time unit, and B₀-B_{N} each represents a probability value output from the second intermediary node at a respective time unit.

In those or other scenarios, the branches comprise first and second parallel branches (e.g., parallel branches 152 and 154 of FIG. 1). Each of the parallel branches comprises an intermediary node (e.g., intermediary node 108 or 110 of FIG. 1). The intermediary node of the first parallel branch (e.g., intermediary node 108 of FIG. 1) is connected in parallel with the intermediary node of the second parallel branch (e.g., intermediary node 110 of FIG. 1). The combining operations of 1110 can comprise: determining whether there is an overlap between a first probability curve defined by first probability values output from the first intermediary node and a second probability curve defined by second probability values output from the second intermediary node; selecting, as one of the plurality of combined probability values, a greatest probability value from one of the first probability values associated with a first time unit and one of the second probability values associated with the first time unit, when a determination is made that there is no overlap between the first and second probability curves; and/or selecting, as one of the plurality of combined probability values, a product of one of the first probability values associated with a first time unit and one of the second probability values associated with the first time unit, when a determination is made that the first and second probability curves overlap at least at the first time unit.

In those of other scenarios, the computing device comprises a network node (e.g., client computing device 802 of FIG. 8) and the task comprises a network communication to a destination node (e.g., another client computing device 802 of FIG. 8) through a network (e.g., network 822 of FIG. 8). A first branch is associated with a first route through the network and a second branch is associated with a different second route through the network. Block 1114 can involve: selecting a route from the first and second routes based on associated combined probability curves; and automatedly controlling the network mode to communicate a message or packet to the destination node over the selected route.

In those or other scenarios, the computing device comprises a robotic device (e.g., robotic device 820 of FIG. 8) which is at least partially moveable to follow a trajectory. A first branch is associated with a first trajectory of a plurality of candidate trajectories, and a second branch is associated with a different second trajectory of the plurality of candidate trajectories. The candidate trajectories can be obtained in accordance with known or to be known techniques. Block 1114 can involve: selecting a trajectory from the first and second trajectories based on associated combined probability curves; and automatedly controlling the robotic device to follow the selected trajectory in accordance with known or to be known techniques.

One of the features of this method is that complex and interconnected networks can be integrated by just including the output probability curves somewhere in a master network or connected network. This method allows the quick and easy combining of networks that may be independently updated or calculated. This enables the use of master schedules for scheduling and master network routing with combined networks.

Another feature of this method is the ability to make decisions based upon 2D information instead of 1D data. An example is in FIG. 11 which shows two network path probabilities with vastly different widths of curves but with the commonly used average being almost the same. The wider curve shows a slightly faster average time of 9.0 vs 9.03 for the narrow curve so with that being the only measurement, the wider curve path is chosen. However, the wide probability curve indicates that there is a large variability in the completion time which could cause synchronization of deliveries problems, staffing issues or other undesirable outcomes. The slightly slower average curve shows very little variability so there is a great deal more certainty around the completion time so synchronizing completion and start efforts will be much more effective and have a much higher certainty with the corresponding benefits. Without this additional 2D information, non-optimal solutions may be chosen.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A method for controlling operations of a computing device, comprising:
obtaining, by a simulation system, a start time for a task;
providing the start time from a single start node of the simulation system to at least two intermediary nodes of one or more branches;
performing, by each of the intermediary nodes, look-up table operations to obtain probability values indicating probabilities that the task will be completed at respective times given the start time, wherein the probability values are indexed in a look-up table by time values;
performing combining operations by a single end node of the simulation system to combine the probability values output from the at least two intermediary nodes to obtain a plurality of combined probability values collectively defining a combined probability curve;
using the combined probability curve to confirm that a completion time for the task will likely be met; and
automatedly controlling operations of the computing device to perform the task based on the using.

2. The method according to claim 1, wherein the one or more branches comprise a serial branch in which a first intermediary node of the at least two intermediary nodes is connected in series with a second intermediary node of the at least two intermediary nodes.

3. The method according to claim 2, wherein the probability values output from the first intermediary node and the probability values output from the second intermediary node are combined in accordance with the following mathematic equation:
$${O}_{N} = {A}_{0} * {B}_{N} + {A}_{1} * {B}_{N - 1} + … + {A}_{N - 1} * {B}_{1} + {A}_{N} * {B}_{0} ,$$
where O_{N} represents an Nth combined value, A₀-A_{N} each represents a probability value output from the first intermediary node at a respective time unit, and B₀-B_{N} each represents a probability value output from the second intermediary node at a respective time unit.

4. The method according to claim 1, wherein the one or more branches comprise first and second parallel branches each comprising an intermediary node of the at least two intermediary nodes, the intermediary node of the first parallel branch being connected in parallel with the intermediary node of the second parallel branch.

5. The method according to claim 4, wherein the combining operations comprise determining whether there is an overlap between a first probability curve defined by first probability values output from the first intermediary node and a second probability curve defined by second probability values output from the second intermediary node.

6. The method according to claim 5, wherein the combining operations further comprise selecting, as one of the plurality of combined probability values, a greatest probability value from one of the first probability values associated with a first time unit and one of the second probability values associated with the first time unit, when a determination is made that there is no overlap between the first and second probability curves.

7. The method according to claim 5, wherein the combining operations further comprise selecting, as one of the plurality of combined probability values, a product of one of the first probability values associated with a first time unit and one of the second probability values associated with the first time unit, when a determination is made that the first and second probability curves overlap at least at the first time unit.

8. The method according to claim 1, wherein the computing device comprises a network node and the task comprises a network communication to a destination node through a network.

9. The method according to claim 8, wherein a first branch of the one or more branches is associated with a first route through the network and a second branch of the one or more branches is associated with a different second route through the network.

10. The method according to claim 9, further comprising selecting a route from the first and second routes based on associated combined probability curves, wherein the computing device is automatedly controlled to communicate a message or packet to the destination node over the selected route.

11. The method according to claim 1, wherein the computing device comprises a robotic device which is at least partially moveable to follow a trajectory.

12. The method according to claim 11, wherein a first branch of the one or more branches is associated with a first trajectory of a plurality of candidate trajectories and a second branch of the one or more branches is associated with a different second trajectory of the plurality of candidate trajectories.

13. The method according to claim 12, further comprising selecting a trajectory from the first and second trajectories based on associated combined probability curves, wherein the robotic device is automatedly controlled to follow the selected trajectory.

14. A system, comprising:
a processor;
a non-transitory computer-readable storage medium comprising programming instructions that are configured to cause the processor to implement a method for controlling operations of a computing device, wherein the programming instructions comprise instructions to:
provide a start time for a task to at least two intermediary nodes of one or more branches of a simulation system;
cause each of the intermediary nodes to perform look-up table operations to obtain probability values indicating probabilities that the task will be completed at respective times given the start time, wherein the probability values are indexed in a look-up table by time values;
cause an end node of the simulation system to perform combining operations to combine the probability values output from the at least two intermediary nodes to obtain a plurality of combined probability values collectively defining a combined probability curve;
use the combined probability curve to confirm that a completion time for the task will likely be met; and
automatedly controlling operations of a computing device to perform the task.

15. The system according to claim 14, wherein the one or more branches comprise a serial branch in which a first intermediary node of the at least two intermediary nodes is connected in series with a second intermediary node of the at least two intermediary nodes.

16. The system according to claim 15, wherein the probability values output from the first intermediary node and the probability values output from the second intermediary node are combined in accordance with the following mathematic equation:
$${O}_{N} = {A}_{0} * {B}_{N} + {A}_{1} * {B}_{N - 1} + … + {A}_{N - 1} * {B}_{1} + {A}_{N} * {B}_{0} ,$$
where O_{N} represents an Nth combined value, A₀-A_{N} each represents a probability value output from the first intermediary node at a respective time unit, and B₀-B_{N} each represents a probability value output from the second intermediary node at a respective time unit.

17. The system according to claim 14, wherein the one or more branches comprise first and second parallel branches each comprising an intermediary node of the at least two intermediary nodes, the intermediary node of the first parallel branch being connected in parallel with the intermediary node of the second parallel branch.

18. The system according to claim 14, wherein the programming instructions further comprise instructions to determine whether there is an overlap between a first probability curve defined by first probability values output from the first intermediary node and a second probability curve defined by second probability values output from the second intermediary node.

19. The system according to claim 18, wherein the programming instructions further comprise instructions to select, as one of the plurality of combined probability values, a greatest probability value from one of the first probability values associated with a first time unit and one of the second probability values associated with the first time unit, when a determination is made that there is no overlap between the first and second probability curves.

20. The system according to claim 18, wherein the programming instructions further comprise instructions to select, as one of the plurality of combined probability values, a product of one of the first probability values associated with a first time unit and one of the second probability values associated with the first time unit, when a determination is made that the first and second probability curves overlap at least at the first time unit.

21. The system according to claim 14, wherein the computing device comprises a network node and the task comprises a network communication to a destination node through a network.

22. The system according to claim 21, wherein a first branch of the one or more branches is associated with a first route through the network and a second branch of the one or more branches is associated with a different second route through the network.

23. The system according to claim 22, the programming instructions further comprise instructions to select a route from the first and second routes based on associated combined probability curves, wherein the computing device is automatedly controlled to communicate a message or packet to the destination node over the selected route.

24. The system according to claim 14, wherein the computing device comprises a robotic device which is at least partially moveable to follow a trajectory.

25. The system according to claim 24, wherein a first branch of the one or more branches is associated with a first trajectory of a plurality of candidate trajectories and a second branch of the one or more branches is associated with a different second trajectory of the plurality of candidate trajectories.

26. The system according to claim 25, the programming instructions further comprise instructions to select a trajectory from the first and second trajectories based on associated combined probability curves, wherein the robotic device is automatedly controlled to follow the selected trajectory.
